(19) United States
(12) Patent Application Publication
(10) Pub. No.: US 2005/0195728 A1
(43) Pub. Date: Sep. 8, 2005

(54) Optical storage media having limited useful life

(75) Inventor: Patrick Larroche, New York, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: FDD Technologies sa/ag/ltd, Zug (CH)

(21) Appl. No.: 10/792,260

(22) Filed: Mar. 2, 2004

(51) Int. Cl. G11B 7/24

(52) U.S. Cl. 369/275.1; 369/53.21

(57) ABSTRACT

An optical disc or other data storage medium has a substrate supporting a data storage region for storing readable data, and is caused to spin or is otherwise subjected to motion when read. A reservoir attached to the substrate and located in proximity to the data storage region stores a liquid reagent by liquid surface phenomena. When the medium is moved in order to read it, the centrifugal or other force causes the reagent to flow from the reservoir to interact with the data storage medium and interfere with the readability of the data.

### FIELD OF THE INVENTION

The present invention relates to optical storage media. In particular, the present invention relates to an optical storage medium including an agent that renders the optical storage medium unreadable after a preselected period of time.

### BACKGROUND OF THE INVENTION

Optical storage media, such as audio and/or visual compact discs (CD) or digital versatile discs (DVD), permit large amounts of data or information to be stored and retrieved. Because of their capacity to store large amounts of data, optical storage media have become enormously popular for delivering computer software, compilations of music, movies, and other types of audio and/or visual materials to consumers.

Typically, data stored in an optical storage medium remains available to the consumer without any practical limit as to the length of time over which the data may be read. Because most of the time the data are stored in the form of read only memory, there are no software limitations introduced in the data to otherwise prevent or limit the availability or readability of the data. However, the absence of any limit to the availability or readability of the data is a drawback in some cases.

A significant factor contributing to the price charged for an optical storage medium is the useful life of the data stored thereon. Because the data remains available for the life of the particular optical storage medium, the data may be repeatedly used by the consumer without remitting any further payment to the content distributor or royalties to the author of the work or data beyond an initial purchase price. As a result, the ability to use data repeatedly may be passed on to consumers in the form of higher purchase prices.

however, this pricing model can result in prices that are unattractive to a consumer who wants to use the content for only a short period. For example, many consumers may wish to view a movie on a DVD medium once, and not wish to pay the price for permanent possession of a copy of the movie. A rental system allows consumers to rent a DVD and pay only for use of the data over a short period, but rental systems are subject to a significant overhead cost because of the need to ensure that the storage medium is returned at the end of the rental period.

By controlling the useful life or the availability of the data, there is the potential to create a revenue stream in purchases of optical storage media, where purchases can be made at rental prices without the overhead of rental returns.

Accordingly, it is desirable to provide an optical storage medium having limited useful life. In particular, it is desired to provide an optical storage medium that controls the period over which the data stored in the optical storage medium remains readable.

### SUMMARY OF THE INVENTION

In one aspect of the invention, there is provided a data storage medium, comprising a substrate supporting a data storage region for storing readable data, arranged in normal use to be subjected to motion when read, a reservoir attached to the substrate and located in proximity to the data storage region for storing a flowable chemical agent and so arranged that the,said chemical agent can flow from the reservoir to interact with the data storage medium and permanently interfere with the readability of the data, wherein the chemical agent is retained in the reservoir substantially solely by liquid surface phenomena. In normal use, force associated with the motion tends to overcome the action of the liquid surface phenomena and cause the chemical agent to flow from the reservoir.

In another aspect of the invention, there is provided a data storage medium arranged to be rotated in use about an axis and comprising a data storage region, an elongate reservoir forming a circular curve centered on the axis, and a chemical agent capable of interacting with the data storage region and permanently reducing the readability of the data. The chemical agent is stored in the elongate reservoir, and is arranged to be released from the reservoir by centrifugal force to interact with the data storage region when the medium is rotated in use.

In a further aspect of the invention, there is provided an optical disc, comprising a reflective layer from which data may be read, and a reservoir for a liquid reagent that can alter the properties of the reflective layer to interfere with reading of the data. The reservoir is radially inward of the data on the reflective layer. The liquid is retained in the reservoir substantially by liquid surface phenomena. Centrifugal force resulting from rotation in the course of normal reading of the disc is sufficient to overcome the surface phenomena and cause radially outward flow of the liquid to interact with the reflective layer.

### BRIEF DESCRIPTION OF THE DRAWINGS

For purposes of illustrating the invention, there are shown in the drawings forms of the invention which are presently preferred; it being understood, however, that this invention is not limited to the precise arrangements and instrumentalities shown. In the drawings:

FIG. 1 is a plan view of one embodiment of an optical storage medium of the present invention.

FIG. 2 is an enlarged detail of part of FIG. 1.

FIG. 3 is a schematic partial sectional view taken along the line 3-3 in FIG. 2.

### DETAILED DESCRIPTION OF THE DRAWINGS

In the drawings, where like numerals identify like elements, there is shown an embodiment of an optical storage medium of the present invention, indicated generally by the reference numeral 10. The optical storage medium 10 is a storage device in which data or other types of information may be stored and read, such as an audio and/or video compact disc, a digital versatile disc (DVD), and the like. The optical storage medium 10 described herein is preferably a DVD, and for simplicity the embodiment of the invention will be described primarily with reference to a DVD.

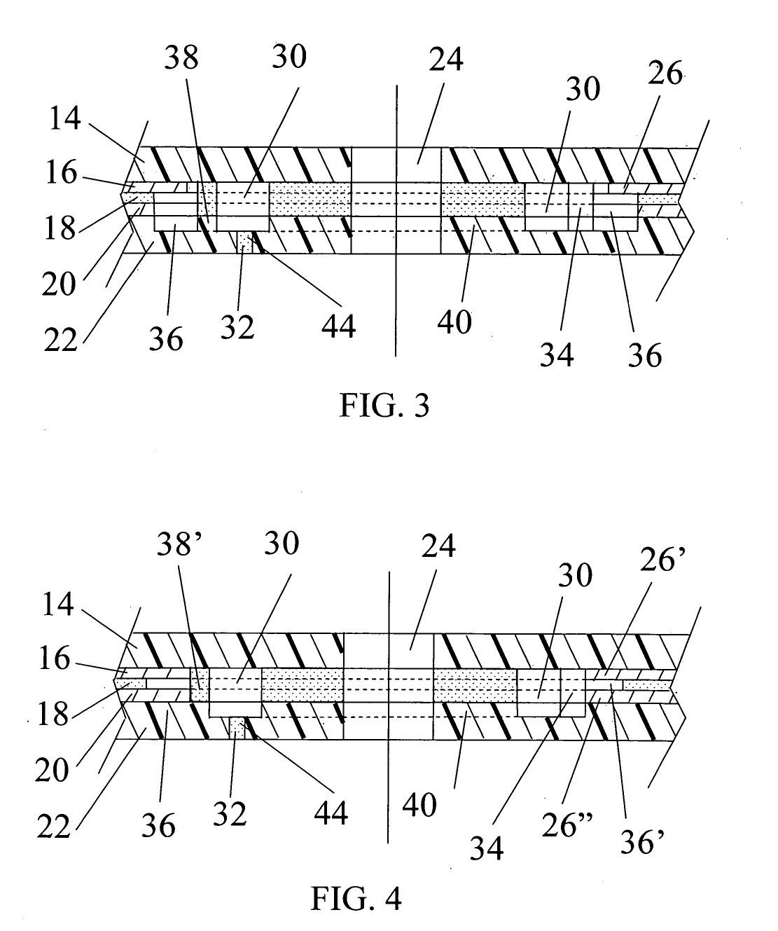

The optical storage medium 10 is circular, having an edge 12 that defines an outer periphery. The optical storage medium 10 is a laminate, as shown in FIG. 3, in which the thickness of the layers has been exaggerated for clarity. In this embodiment, the laminate consists essentially of, in order, a first rigid substrate 14, a first layer of reflective material 16, a layer of adhesive 18, a second layer of reflective material 20, and a second rigid substrate 22. The substrates 14 and 22 include a central aperture or opening 24 and are made of transparent material, such as glass or plastic. In the embodiment shown in the drawings, the substrates 26 are made of transparent polycarbonate plastic.

In the disclosed embodiment, the first reflective layer 16 is an aluminum coating formed on the first rigid substrate 14, and the second reflective layer 20 is an aluminum coating formed on the second rigid substrate 22. The two halves thus formed are then joined together with a layer of hot-melt glue or other adhesive 18, as will be described in more detail below. This and other ways of assembling the various layers into the completed disc will be apparent to those skilled in the art and need not be described here in detail.

The optical storage medium 10 includes readable data or information represented by pits, bumps, dots, or other markings formed in the first reflective layer 16 and having a reflectivity different from the reflectivity of other markings or of unmarked parts of the first reflective layer 16. The markings are scanned by a laser through the first rigid substrate 14 to read the data. In the disclosed embodiment, the markings are preferably pits or dots molded into the surface of the first substrate 14 before the first substrate is coated with the first reflective layer 16. Various methods for forming the first rigid substrate 14 and the first reflective layer 16 are known and, in the interests of conciseness, will not be further described here.

The second rigid substrate 22, with the second reflective layer 20 applied to it as a coating, may be similarly formed. The second reflective layer 20 may be a further data storage layer, read either through the first rigid substrate 14 and the first reflective layer 16, if the first reflective layer 16 is partly reflective and partly transparent, or through the second rigid layer 22. Alternatively, the second reflective layer 20 may be merely a dummy layer. If the second reflective layer 20 is not used for data storage, it may be omitted. In accordance with the industry standard for DVDs and CDs, the data stored on the first reflective layer 16 starts with a lead-in section 26 at the radially inner edge of the first reflective layer, nearest to the central aperture 24. This configuration is especially suitable for a DVD-9 format disc, in which the first reflective layer 16 is read from the inside outwards, and the second reflective layer 20 is then read from the outside inwards.

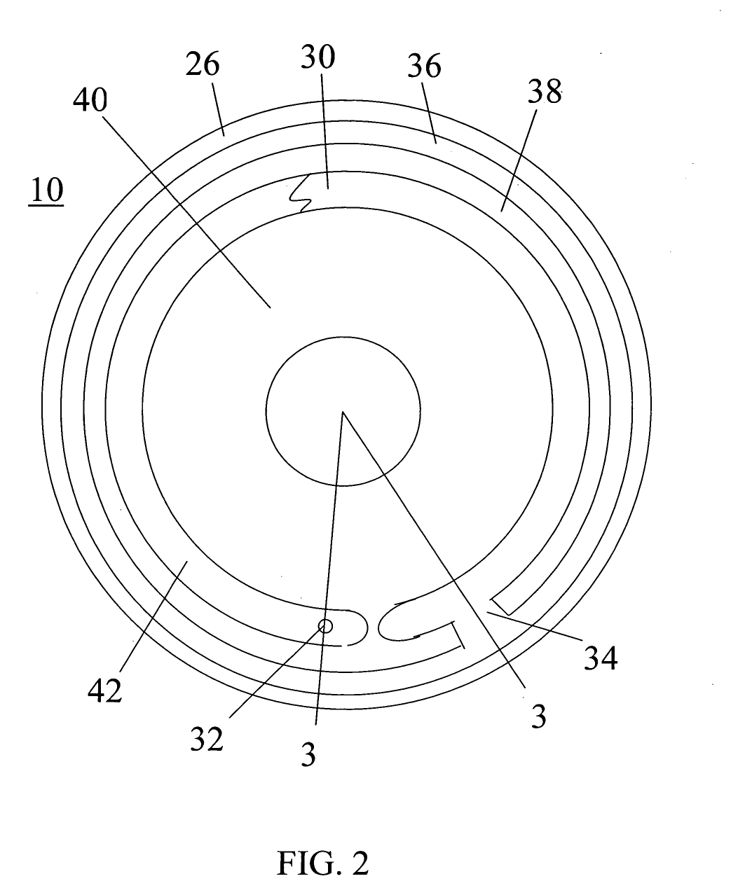

Referring now especially to FIGS. 2 and 3, a first reservoir 30 is formed in the second rigid substrate 22. The first reservoir is in the form of an annular groove in the inner face of the second rigid substrate 22, concentric with the disc 10 and extending round a majority of arc of the disc 10, for example, for approximately 350° of arc. The first reservoir or groove 30 is separated from the central aperture of the disc 10 by a land 40. Near one end, the groove 30 is connected with the exterior by a hole 32 passing through the thickness of the second rigid substrate 22. Near the other end, the groove 30 is connected by a radial passageway 34 to a second reservoir or groove 36. The second reservoir 36 is annular, and is concentric with the disc 10 and is radially outside the first reservoir 30. A wall 38 separates the first reservoir 30 from the second reservoir 36, and is penetrated only by the radial passageway 34.

The second reflective layer 20 has its inner edge at the outer edge of the second reservoir 36. However, the lead in section 26 of the first reflective layer 16 overlaps, and forms at least part of one wall of, the second reservoir 36. The first reflective layer 16 does not overlap the first reservoir or groove 30. Preferably, the inner edge of the first reflective layer 16 is outside the wall 38. Because the position of the lead-in section 34 is effectively determined by the industry standard for CDs, DVDs, and similar media, this effectively determines the radial position of the second reservoir 36. If the second reflective layer 20 is the second data layer of a DVD-9 disc, the DVD-9 standard tolerates having the inner, lead-out edge of the second data layer a few millimeters further out than usual.

The adhesive 18 is applied by coating the second rigid substrate 22, and the second reflective layer 20 already laminated onto the second rigid substrate. Preferably, the adhesive 18 is applied with a hard roller or similar that will coat the surfaces it touches, including the wall 38 and the land 40, but will not apply any adhesive into or over the recesses forming the reservoirs 30 and 36 and the passageway 34. This ensures that the lead-in section 26 is exposed to the outer reservoir 36, while the inner reservoir 30 is entirely enclosed by polycarbonate and adhesive.

Once the disc 10 has been assembled, a liquid chemical agent 42 is introduced into the first reservoir 30 through the hole 32, which is then sealed. In one embodiment, the chemical agent 42 is introduced by extracting air from the reservoirs 30 and 36 to form a partial vacuum, then allowing atmospheric pressure to force the liquid 42 into the first reservoir 30 until the reservoirs are substantially at atmospheric pressure. After the liquid 42 is introduced, the hole 32 is then sealed with a drop of adhesive 44.

In normal storage and handling of the disc 10, the liquid 42 is retained in the part of the first reservoir 30 nearest the hole 32 by surface tension. The amount of liquid introduced is not critical, but it is preferred to approximately half fill the first reservoir 30. This allows a reasonable amount of liquid 42, while leaving a substantial length of dry groove 30, so that even if sudden movements of the disc 10 cause some migration of the liquid 42 it is very unlikely to reach the passageway 34.

However, when the optical storage medium 10 is used, the disc is rotated very rapidly, typically at 1000 rpm, to allow it to be read by a fixed laser. This rapid rotation generates a considerable centrifugal force. Assuming that the first reservoir 30 has a radius of 40 mm, the acceleration experienced by the liquid 42 in the first reservoir is about 218 m/s², or more than 20 times the acceleration due to gravity at the earth's surface. This acceleration drives the liquid 42 to the radially outer edge of the groove 30, and causes it to spread along that edge until it reaches the passageway 34. The liquid 42 then spreads along the outer edge of the second reservoir 36, where it comes into contact with the lead-in section 26 of the data on the first reflective layer 16.

The liquid 42 in the first reservoir 30 is a preselected chemical agent that will render the lead-in section 26 of the optical storage medium 10 unreadable after a preselected period of time, by dissolving or otherwise reacting with the aluminum layer 16 and altering its reflectivity so that the laser cannot read the data. In the preferred embodiment, the liquid 42 dissolves away the aluminum layer 16 over a period of from several minutes to a few days. It is not necessary to obliterate the data on the first reflective layer 16 entirely. Merely damaging the lead-in section 24, renders the disc 10 unusable in any standard DVD or CD player, because the player relies on information in the lead-in section to identify and locate the data files stored on the main part of the disc. This is not a high-security method of disabling the storage medium 10, because its data content can still be read by with specially adapted reading devices, but it is sufficient for large-scale distribution to the general public.

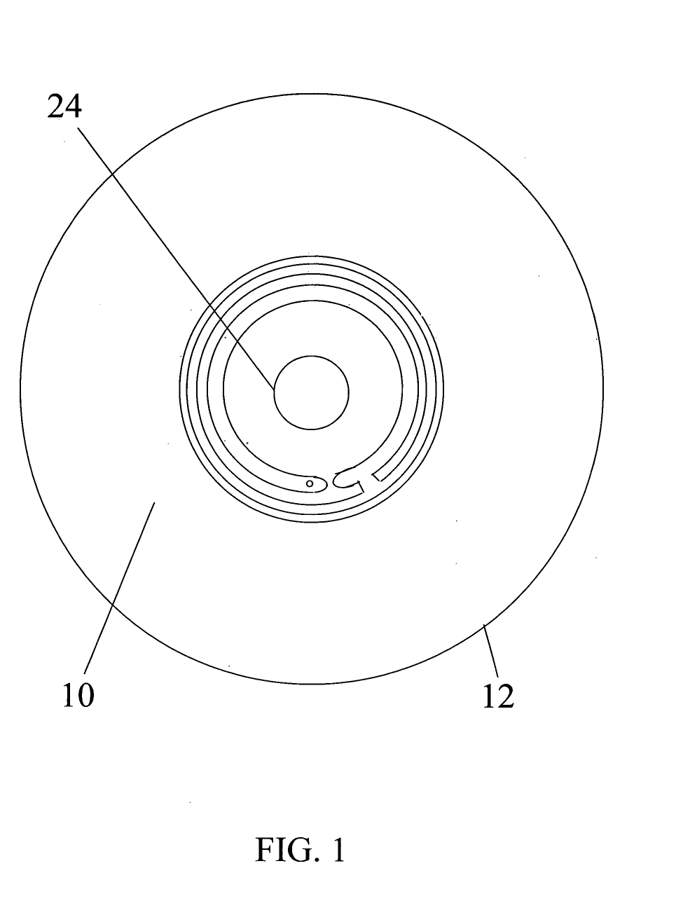

Referring now to FIG. 4, a second embodiment 10′ of the optical storage medium of the invention is generally similar to the first embodiment shown in FIGS. 1 to 3, and like elements have been indicated by like reference numerals. However, in the second embodiment 10′ there is no second reservoir or groove formed in the second rigid substrate 22. Both the first and the second reflective layers 16 and 20 extend inwards to the outer edge of the wall 28′ separating the first reservoir 30 from the second reservoir 36′. As shown in FIG. 3, the wall 28′ may consist of a strip of adhesive 18. Alternatively, the wall 28′ may consist in part of a raised rib on the second rigid substrate 22.

The second reservoir 36′ is formed by a region along the inner edges 26′ and 26″ of the first and second reflective layers 16 and 20 where the adhesives 8 is not applied, so that the reflective layers are separated by a narrow gap with which the passageway 34 communicates. It will be appreciated that in this embodiment the adhesive 18 cannot be applied simply with a stiff roller, but any suitable masking or printing technique may be used to form the desired pattern of adhesive. As is shown schematically in FIG. 4, the gap 36′ is narrower than the reservoir 30 or 36, so a liquid chemical agent 42 that flows easily over the material of the reflective layers 16 and 20 is preferred.

The embodiment shown in FIG. 4 is suitable for double-sided or dual-layer disc formats in which each side is read from the inner edge to the outer edge. In these formats, the inner edges of both reflective layers 16 and 20 are at the same standard radius, so that the reading device can find the lead-in sections, and the embodiment shown in FIG. 3 is less suitable. The embodiment shown in FIG. 4 is especially suitable for a disc format in which each side is separately formatted, because the liquid chemical agent 42 will react with the lead-in sections 26′, 26″ of both reflective layers. Both sides are thus simultaneously rendered unreadable.

Those of ordinary skill in the art will appreciate that aluminum has relatively low reactivity in that, due to its characteristics, it is protected by a cover of oxide at any time. Despite this low reactivity, aluminum is known to react to certain chemicals under certain conditions and circumstances when the aluminum oxide is dissolved by a chemical agent that can, because of the dissolution of the oxide, react with the aluminum. For example, aluminum is sensitive to bases such as NaOH or KOH, acids such as HCl, H₂SO₄, NHO₃, and citric acid, and several metallic salts, such as CuSO₄, as a few examples.

The properties of these chemical agents may be advantageously used to facilitate and control the rate of dissolution or corrosion of the aluminum. For example, the corrosion of an aluminum reflective layer 16 may be steady and uniform with certain agents, such as NaOH or HCl, or may become pitted upon exposure to agents such as CuSO₄. In particular, a solution of NaOH with a concentration of 0.06 g/l and a pH of 11 generates a rate of dissolution of the aluminum reflective layer 16 ranging anywhere between approximately 0.3 micron per hour and approximately 1.0 micron per hour. Inhibitors like soda silicate can reduce or delay the action of NaOH, thereby reducing the rate of dissolution of the aluminum of the reflective layer 16, and extending the period over which the data will become unreadable.

As an additional example, a solution of HCl with a concentration of 5.0% produces a rate of dissolution of the aluminum of the reflective layer 16 ranging anywhere between approximately 1.0 microns per 24 hours and approximately 3.0 microns per 24 hours. Inhibitors can reduce or delay the effects of the HCl even further, thereby reducing the rate of dissolution, and extending the period over which the data will be readable.

As yet another example, a solution of CuSO₄ with a concentration of 1.0% produces a rate of dissolution of the aluminum of the reflective layer 16 ranging anywhere between approximately 1.0 microns per 24 hours to approximately 2.0 microns per 24 hours.

In a typical DVD, the thickness of the aluminum reflective layers is typically 40 or 50 nanometers. With the above-mentioned reagent solutions, therefore, a reasonable operating life of from several minutes to a few days will require either that the lead-in portion 26 of the first reflective layer 16 be specially thickened, or that a weaker solution of the reagent be used.

As yet another example, a mixture of one part saturated citric acid, two parts saturated NaCl, and twenty parts water disables a typical aluminum reflective layer in a DVD in between 8 and 24 hours at room temperature.

Care should be taken that the liquid chemical agent 42 does not dissolve the polycarbonate or other material of the substrates 14 and 22, and does not dissolve the adhesive 18. Even if the disc 10 is kept for a long period after it ceases to be usable, the liquid 42 is unlikely to dissolve out along the layers of reflective material 16 and 20 and escape at the edge of the disc, because of the narrowness of the gap that would be formed by such dissolution. The liquid 42 should, however, not be such a strong corrosive agent that it would create a hazard to persons or property if the liquid were released by breaking the disc 10.

Those of ordinary skill will appreciate that the dissolution of the aluminum, and the period after which the optical storage medium 10 will become unreadable, will depend on many factors. Those factors include the thickness of the aluminum and the characteristics of the chemical agent. For example, the relative thickness of the aluminum may be selectably adjusted to control the time needed by the chemical agent to at least partially dissolve the aluminum sufficiently to reach the polycarbonate layer or substrate 14 so as to destroy the availability of the data. The chemical properties of the chemical agent may also be selectably adjusted to control the period over which the data of a particular optical storage medium 10 will become unreadable.

Another factor is the type of metallic material used for the reflective layer 16. Although aluminum is presently preferred, other types of metallic material having properties similar to aluminum may be used with the optical storage medium 10. Therefore, the type of metallic material used for the reflective layer 16 should be taken into account to determine the type, concentration, and amount of the chemical agent 42 needed.

Because the liquid chemical agent 42 is retained in the first reservoir 30 solely by capillary action, the surface tension of the liquid and the readiness with which that liquid wets the material forming the first reservoir and the second reservoir 36 are important. It has been found that with a water-based liquid 42 that does not contain any additives materially altering the surface tension or wetting properties, and polycarbonate substrates 14 and 22, a first reservoir from 0.03 mm to 0.4 mm deep in the axial direction is suitable. A depth of 0.25 mm is preferred. In the embodiment shown in the drawings, the radial width of the first reservoir 30 is 3.5 mm. Because of the large difference between the width and the depth, only the depth is important. If the reservoir 30 is too shallow, then the liquid 42 will not reliably be forced to flow by the centrifugal force at the normal operating speed of a CD or DVD. If the reservoir 30 is too deep, then the liquid 42 may flow out too easily before the disc 10 is used.

Those skilled in the art will understand that other liquids may require different dimensions for the reservoirs 30 and 36. For example, an alcohol based liquid may wet the substrates more readily than water, and may therefore require a shallower reservoir. Also, if an ink is added to make the liquid 42 visible, and thus make it easier to see if the liquid has been expelled into the second reservoir, it should be borne in mind that many inks contain a surface active agent that may affect the behavior of the liquid.

While it is not necessary for the liquid 42 to spread round the entire periphery of the second reservoir 36 or 36′, it is desirable for the liquid to spread freely. Because the second reservoir 36 or 36′ is bounded partly by the aluminum or other reflective material of the lead-in section 26, or is bounded by the reflective material of the lead-in sections 26′ and 26″, the behavior of the liquid 42 may be different in the first and second reservoirs. The water-based liquids mentioned above are particularly suitable in the present embodiments, because they wet aluminum more readily than they wet polycarbonate, so they flow more freely in the second reservoir 36 or 36′ than in the first reservoir 30. This is particularly useful in the embodiment 6f FIG. 4, where the second reservoir 36″ is narrow, and is bounded on both sides by aluminum.

The optical storage media of the present invention described above provides several advantages in the content media market. For example, the optical storage media of the present invention may be used as promotional material in point of sale purchases. When used as promotional material, the data stored in the optical storage media of the present invention may be used to offer on a trial basis software, music, movies, or other types of audio or visual data which may be used over a preselected period of time, such as a number of hours or days. At the expiration of the period of time, the optical storage media will have been rendered unreadable and will have to be discarded, and the consumer will have to purchase the data on a more permanent storage medium. In addition, the optical storage media may be used by hotels to offer movies, either free or at a price, that must be used within a specific period of time, such as in a day or in a few hours, after which the media will have been rendered unreadable and must be discarded.

As another example, the optical storage media of the present invention may be used in the movie rental industry. Often, movies in today's market are available to consumers as rental items in which the particular storage medium, such as a video cassette containing the movie, is rented for a fee. In exchange for paying the rental fee, the consumer is permitted to use the storage medium over a set period of time, such as three days, after which it has to be returned.

At the end of three days, the video cassette is returned (if at all) and must be checked to ensure that it is rewound, and restocked so that it may be rented again. However, by using the optical storage media of the present invention (such as an audio and/or visual DVD), the optical storage medium may be offered as a one-time purchase instead of a rental. As a one time purchase, the optical storage medium may be used for a preselected period of time, such as a few days, as desired. After the preselected period of time has expired, the optical storage media will no longer be useful, and can be discarded. In comparison to video cassettes, or standard CDs or DVDs, the content media distributor does not have to worry about the optical storage media being returned (if at all) and/or rewound. Rather, the content media distributor will simply have to maintain a supply of optical storage media to be purchased by the consumer; Thus, the costs associated with rental items such as movies may be reduced.

Furthermore, by utilizing optical storage media of the present invention, the content media distributor can have more control over the extent to which copies of the data are made. By limiting the availability of the data, the content media distributor may reduce the extent to which consumers will have the opportunity to make multiple copies of the data to avoid paying the cost to purchase the optical storage media. By reducing the risk of multiple copies, there is the potential to increase in the amount of optical storage media purchased. As a result, the increased purchases have the potential to generate revenue to the content media distributor or the author or inventor of the work or data.

The optical storage media of the present invention are especially advantageous because the process that limits the usable life of the medium 10 is initiated by the simple act of placing the storage medium in a player and operating the player. The media of the present invention do not require special storage containers to inhibit the starting of the process that limits the usable life. They do not require devices that have to be removed by special manipulations that activate the life-limiting process. The media of the present invention can be distributed in standard containers, and can be played without the user doing anything different from what he or she would do when playing a corresponding conventional storage medium.

The present invention has been described in reference to an optical storage medium 10 or 10′ in the form of a circular disc with a lead-in section or other key data at the inner periphery of an annular data area. This is an advantageous form of medium for application of the present invention, because a rapidly-rotating disc is a widely used format, and because an optical disc typically relies on a thin reflective layer that is easily attacked by a chemical agent. However, it is contemplated that the optical storage medium can have any shape or size, provided only that its reading requires a rapid rotation or other movement. It is also contemplated that the optical storage medium may be replaced by other types of audio, visual, or computer software data storage devices on which data or information may be selectably stored and read. It is also contemplated that processes other than corroding a thin data storage layer may be used. For example, the liquid 42 might interfere with the transparency of a covering layer. Processes that affect the physical dimensions of the disc are possible, but are not preferred, because they can result in a disc becoming jammed in, or even damaging, a reader.

Although an optical storage medium 10 in which a lead-in section at the radially inner edge of the reflective layer 16 or 20 is disabled has been described, other embodiments are possible. For example, the area of the reflective layer that is rendered unreadable need not be a lead-in area or other region that contains key data for the reading of the rest of the medium. Any part of the data on the disc could be rendered unreadable, provided that the loss of that data materially impairs the usefulness or value of the disc as a whole.

By positioning the first reservoir 30 further out, and/or by extending the passageway 34, the liquid 42 can be directed to a part of the disc other than the radially inner edge of the reflective layers 16 and/or 20. It will be appreciated that if the first reservoir 30 is in a part of the disc where a data-storing part of the reflective layer 16 or 20 is present, then the liquid 42 in the first reservoir must be prevented from attacking the adjacent part of the reflective layer prematurely.

Persons skilled in the art will recognize that there may be different devices, mechanisms, and methods of operation which are within the spirit and scope of the invention as defined in the claims. Also, it should be understood that the drawings, while useful in illustrating the invention, are not intended to be necessarily to scale. The dimensions and relative sizes and locations of the various parts shown can be varied, depending upon the particular optical storage media being used, without departing from the scope of the invention. To the extent that the drawings imply dimensions and relative size positions, the drawings should be regarding as illustrative only and not limiting the invention to particular dimensions, sizes, position, and location of parts.

The present invention may be embodied in other specific forms without departing from the spirit or essential attributes thereof and, accordingly, reference should be made to the appended claims, rather than to the foregoing specification, as indicating the scope of the invention.

1. A data storage medium, comprising:
a substrate supporting a data storage region for storing readable data, and being subjected in normal use to be to motion when read;
a reservoir attached to the substrate and located in proximity to the data storage region for storing a flowable chemical agent and so arranged that the said chemical agent can flow from the reservoir to interact with the data storage medium and permanently interfere with the readability of the data;
wherein the chemical agent is retained in the reservoir substantially solely by liquid surface phenomena, and wherein in normal use force associated with the motion tends to overcome the action of the liquid surface phenomena and cause the chemical agent to flow from the reservoir.

2. A data storage medium according to claim 1, wherein the data storage region comprises a data storage layer.

3. A data storage medium according to claim 1, wherein the chemical agent interacts with the data storage medium by damaging part of the data storage region.

4. A data storage medium according to claim 3, wherein the data storage medium comprises a reflective layer in which data is readable by variations in reflection, and the chemical agent interacts with the data storage medium by changing the reflection of the reflective layer.

5. A data storage medium according to claim 1, wherein the substrate is arranged in use to be rotated, and the force associated with the rapid motion comprises centrifugal force.

6. A data storage medium according to claim 1, wherein the reservoir is elongate and has an outlet for the chemical agent at one end, and wherein the reservoir is only partially filled at the end further from the outlet.

7. A data storage medium according to claim 6, wherein the substrate is rotated about an axis in use, the force associated with the motion comprises centrifugal force, and the elongate reservoir is a circular arc centered oh the axis of rotation.

8. A data storage medium according to claim 1, wherein the liquid is arranged to be caused to flow from the reservoir by an effective acceleration greater than 100 m/s².

9. A data storage medium according to claim 8, wherein the liquid is arranged to be caused to flow from the reservoir by an effective acceleration of about 200 m/s².

10. A data storage medium rotated about an axis in use and comprising:
a data storage region;
an elongate reservoir forming a circular curve centered on the axis; and
a chemical agent capable of interacting with the data storage region and permanently reducing the readability of the data;
wherein the chemical agent is stored in the elongate reservoir, and is arranged to be released from the reservoir by centrifugal force to interact with the data storage region when the medium is rotated in use.

11. A data storage medium according to claim 10, wherein the reservoir has a outlet for the chemical agent at one circumferential end, and wherein the reservoir is only partially filled at the end further from the outlet.

12. A data storage medium according to claim 10, wherein the data storage region comprises a data storage layer.

13. A data storage medium according to claim 10, wherein the chemical agent interacts with the data storage medium by damaging part of the data storage region.

14. A data storage medium according to claim 13, which is an optical storage medium having a reflective layer in which data is readable by variations in reflection, and the chemical agent interacts with the data storage medium by changing the reflection of the reflective layer.

15. A data storage medium according to claim 10, wherein the chemical agent is arranged to reduce the readability of a part of the data necessary for locating or interpreting other data on the disc.

16. A data storage medium according to claim 10, which is arranged in use to be rotated at a speed greater than 500 rpm.

17. A data storage medium according to claim 16, which is arranged in use to be rotated at a speed of about 1000 rpm.

18. A data storage medium according to claim 10, which is a disc, wherein the data storage region is an annular region, and wherein the reservoir is radially inward of the annular region, and wherein the liquid is arranged to flow outwardly under the action of centrifugal force to the data storage region.

19. A data storage medium according to claim 18, wherein the liquid flows from the reservoir to an annular second reservoir to which a radially inner part of the data storage region is exposed.

20. A data storage medium according to claim 10, wherein the liquid is retained in the reservoir substantially by surface tension.

21. A data storage medium according to claim 10, wherein the reservoir is from about 0.03 mm to about 0.4 mm across in the narrowest direction.

22. A data storage medium according to claim 10, wherein the liquid comprises a reagent selected from the group consisting of citric acid and sodium chloride in aqueous solution.

23. An optical disc, comprising:
a reflective layer from which data may be read; and
a reservoir for a liquid reagent that can alter the properties of the reflective layer to interfere with reading of the data;
wherein the reservoir is radially inward of the data on the reflective layer;
wherein the liquid is retained in the reservoir substantially by liquid surface phenomena; and
wherein centrifugal force in normal reading of the disc is sufficient to overcome the surface phenomena and cause radially outward flow of the liquid to interact with the reflective layer.

24. An optical disc according to claim 23, wherein the reservoir is elongate and extends around the center of the disc.

25. An optical disc according to claim 24, wherein the reservoir has an outlet at one end, and is partially filled with liquid reagent at the other end.

26. An optical disc according to claim 23, wherein the liquid reagent flows from the reservoir to contact a lead-in section at the inner edge of the reflective layer.

27. An optical disc according to claim 23, wherein the reservoir is from about 0.03 mm to about 0.4 mm wide in its narrowest direction.
